(19) United States
(12) Patent Application Publication
(10) Pub. No.: US 2024/0208436 A1
(43) Pub. Date: Jun. 27, 2024

(54) CABLE HOLDER FOR A VEHICLE

(71) Applicant: Oshkosh Corporation, Oshkosh, WI (US)

(72) Inventors: Ryan Gutenberger, Rochester, MN (US); Ryan Rowe, Oshkosh, WI (US)

(73) Assignee: Oshkosh Corporation, Oshkosh, WI (US)

(21) Appl. No.: 18/541,717

(22) Filed: Dec. 15, 2023

Related U.S. Application Data
(60) Provisional application No. 63/434,375, filed on Dec. 21, 2022.

(51) Int. Cl. B60R 16/02

(52) U.S. Cl. CPC B60R 16/0215

(57) ABSTRACT

A cable holder for a vehicle comprising a body portion defining an engagement surface and a plurality of holes, and a first hook, a second hook, and a third hook, wherein the first hook, the second hook, and the third hook each define a curved engagement surface. The first hook, the second hook, and the third hook are configured to receive a cable to removably couple the cable with the cable holder by engaging an exterior surface of the cable at the curved engagement surface, where the first hook, the second hook, and the third hook are manufactured from a flexible material such that the cable breaks away from the cable holder when a first force is exerted on the cable to pull the cable away from the cable holder without transferring a second force to a component of the vehicle that the cable holder is coupled to.

### CROSS-REFERENCE TO RELATED PATENT APPLICATION

This application claims the benefit of and priority to U.S. Provisional Application No. ______, filed on ______, the entire disclosure of which is hereby incorporated by reference herein.

### STATEMENT REGARDING FEDERALLY-SPONSORED RESEARCH OR DEVELOPMENT

This invention was made with Government support under agreement number M67854-21-9-1839, awarded by Marine Corps Systems Command. The Government has certain rights in this invention.

### BACKGROUND

The present disclosure relates to electrical systems of a vehicle. More particularly, the present disclosure relates to coupling cables of vehicle electrical systems to a vehicle.

### BRIEF DESCRIPTION OF THE DRAWINGS

FIG. 1 is a perspective view of a vehicle with a cable holder, according to some embodiments.

FIG. 2 is a diagram of the cable holder of FIG. 1, according to some embodiments.

FIG. 3 is a perspective view of the cable holder of FIG. 1, according to some embodiments.

FIG. 4 is a perspective view of another cable holder, according to some embodiments.

FIG. 5 is a perspective view of the cable holder of FIG. 1 with a cable coupled between hooks, according to some embodiments.

FIG. 6 is a diagram of the cable holder of FIG. 1 including electrical components for detecting if a cable is installed on the cable holder, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a cable holder includes hooks that are made from a flexible material. The cable holder is configured to receive a cable and secure the cable between the hooks. The cable holder may be configured to allow release of the cable when the cable is pulled without damaging the cable holder or a portion of a vehicle to which the cable holder is fastened.

### Vehicle

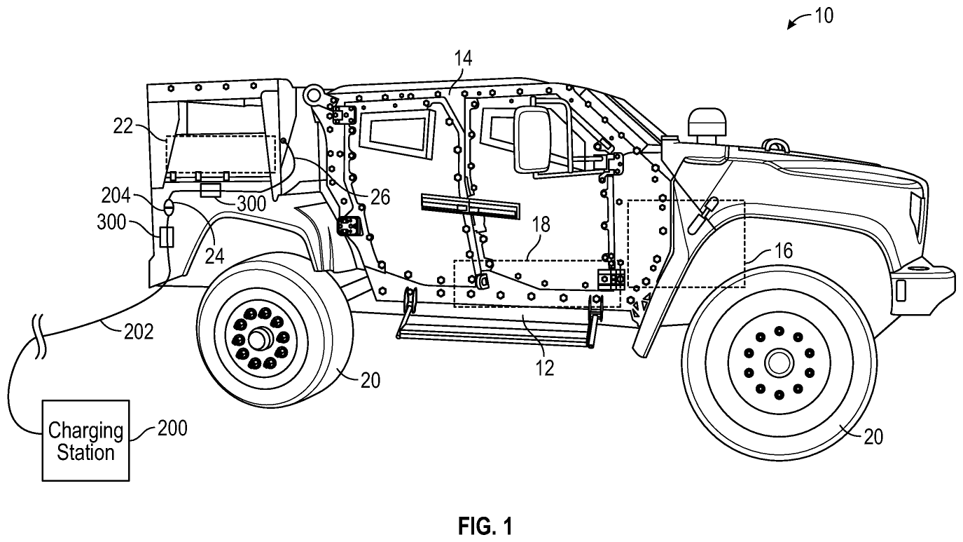

Referring to FIG. 1, a vehicle 10 (e.g., a military vehicle, a commercial vehicle, a fire fighting truck, a refuse vehicle, a lift device, a concrete mixer vehicle, a boom, a telehandler, a truck, etc.) includes a chassis 12 (e.g., a frame, a pair of beams, etc.) and a prime mover 16. The prime mover 16 may be coupled with the chassis. The prime mover 16 may be an engine (e.g., a diesel engine, a fuel cell, a gasoline engine, etc.) or an electric motor. The vehicle 10 also includes a transmission 18, and tractive elements 20 (e.g., wheels, tracks, treads, tires, etc.). The prime mover 16 is configured to operate to drive the tractive elements 20 to transport the vehicle 10 (e.g., through the transmission 18 and one or more driveshafts, differentials, gear boxes, gearing systems, etc.). In some embodiments, the vehicle 10 also includes a body 14 having one or more electrical accessories. The vehicle 10 also includes a battery 22 (e.g., a power storage device, an electrical energy storage device, etc.) that is configured to store electrical energy and discharge the electrical energy to the prime mover 16, an accessory power unit, the one or more electrical accessories of the body 14, a controller or control system of the vehicle 10, or any other electrical component of the vehicle 10.

In some embodiments, the battery 22 may be charged through a wired connection, shown as cable 26. The cable 26 can include an electrical connector 24 (e.g., an electrical energy connector, a communications connector, etc.). The wire 26 is coupled with an exterior surface of the body 14 or the chassis 12 through a cable holder 300. The battery 22 may be charged by a charging station 200 that is configured to provide electrical energy or power to the battery 22 through a cable 202. In some embodiments, the cable 202 includes an electrical connector 204 at an end that is configured to electrically couple or connect with the electrical connector 24 of the cable 26. In some embodiments, the cable 202 and the cable 26 are data transmission cables that are configured to facilitate the exchange of data between a controller and a human machine interface (HMI), a controllable element (e.g., an electric motor, an electric linear actuator, etc.). In some embodiments, the vehicle 10 includes cables that are configured to transfer power from an on-board battery or electrical storage system (e.g., the battery 22) to one or more electrical components of the vehicle 10 (e.g., the prime mover 16). As shown in FIG. 1, the cable 202 (e.g., a charging cable, a shore power connection, a building cable for both air and electric, etc.) is also removably coupled or secured with an exterior of the body 14 or the chassis 12 by another cable holder 300. In some embodiments, the data transmission cables or the cables that transfer power from the on-board battery or electrical storage system are removably coupled with the chassis 12 or the body 14 by cable holders 300. The cable holders 300 facilitate securing or coupling cables to the vehicle 10 in a removable or break-away manner such that if the cables become tangled or are pulled (e.g., during operation of the vehicle 10, by an individual yanking on the cable, etc.), the cables break-away from the cable holder 300 without causing damage to the vehicle 10 (e.g., without causing damage to the body 14). In some embodiments, the cable holders 300 can also be configured to keep cables from obstructing a moving element of the vehicle 10 (e.g., the tractive elements 20) by routing the cable around the moving element. The cable holders 300 may facilitate reducing tripping hazards and reduce a likelihood that a cable will be run over or become tangled in the tractive elements 20 while allowing the cable to easily be attached or removed from the cable holder 300 such that the cable can break away without causing damage to the vehicle 10.

### Cable Holder

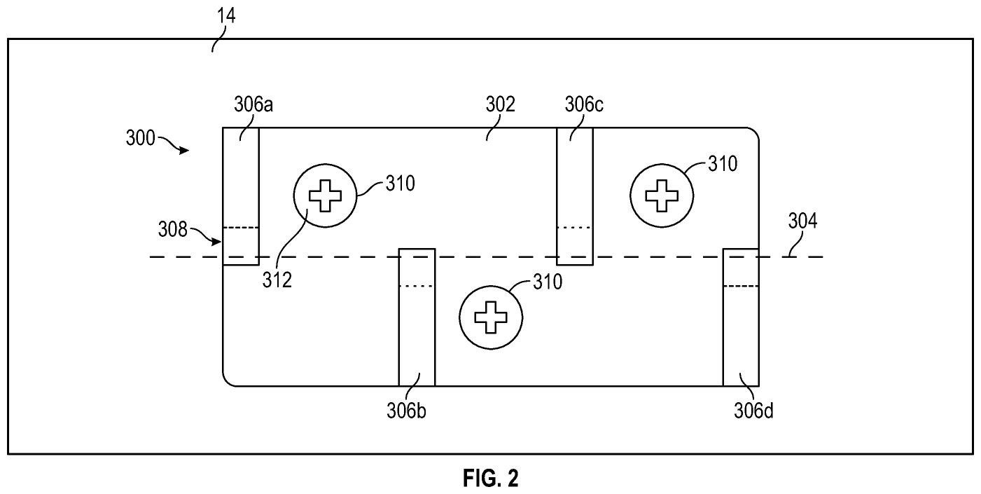

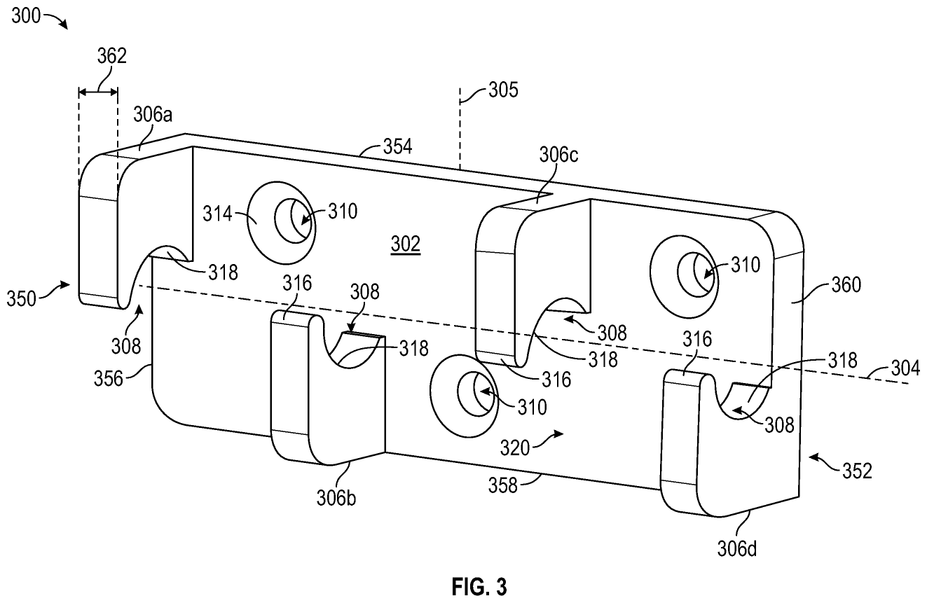

Referring to FIGS. 2-3, the cable holder 300 includes a body 302 (e.g., a plate, a main portion, a central portion, a planar member, etc.) that defines a surface 320. The surface 320 may be a planar surface and can be engaged by an exterior surface of a cable to facilitate holding the cable on the cable holder 300. The body 302 includes one or more openings, shown as holes 310 which are surrounded by a chamfered surface 314 that extends circumferentially around the holes 310. The holes 310 and the chamfered surfaces 314 are configured to receive and engage with a portion of a fastener 312 (e.g., a screw) that extends through the body 302 and threadingly couples with inner surfaces or threads of a corresponding aperture or hole of the body 14 or chassis 12 of the vehicle 10.

The cable holder 300 also includes a plurality of hooks 306 (e.g., rungs) that are configured to hold the cable. Specifically, the cable holder 300 includes a first hook 306a, a second hook 306b, a third hook 306c, and a fourth hook 306d. The first hook 306a, the second hook 306b, the third hook 306c, and the fourth hook 306d are integrally formed with the body 302. The first hook 306a is positioned at a first end 350 (e.g., a first longitudinal end) of the body 302. The fourth hook 306d is positioned at a second end 352 (e.g., a second longitudinal end) of the body 302 that is opposite the first end 350. The second hook 306b and the third hook 306c are longitudinally positioned along the body 302 at positions between the first hook 306a and the fourth hook 306d.

In some embodiments, the body 302 defines a longitudinal axis 304 that extends through the body 302 or extends lengthwise along the body 302. In some embodiments, the body 302 also defines a lateral axis 305 that extends laterally through the body 302 or in a widthwise direction of the body 302. The lateral axis 305 may be perpendicular with the longitudinal axis 304. The longitudinal axis 304 generally defines a longitudinal direction along the body 302 of the cable holder 300. The lateral axis 305 similarly defines a lateral direction along the body 302 of the cable holder 300.

The body 302 includes or defines a first lateral surface 354, a first longitudinal surface 356, a second lateral surface 358, and a second longitudinal surface 360. The first lateral surface 354 and the second lateral surface 358 may be oriented such that the lateral axis 305 extends substantially normal to the first lateral surface 354 and the second lateral surface 358. In some embodiments, a lateral face or surface of the first hook 306a and a lateral face or surface of the third hook 306c are coincident or coplanar with the first lateral surface 354. Similarly, a lateral face or surface of the second hook 306b and a lateral face or surface of the fourth hook 306d are coincident or coplanar with the second lateral surface 358. In some embodiments, the first hook 306a is positioned at a corner between the first lateral surface 354 and the first longitudinal surface 356 and extends from the surface 320. In some embodiments, the fourth hook 306d is positioned at a corner between the second longitudinal surface 360 and the second lateral surface 358 and extends from the surface 320. In some embodiments, the first hook 306a includes a longitudinal surface that is coplanar with the first longitudinal surface 356. In some embodiments, the fourth hook 306d includes a longitudinal surface that is coplanar with the second longitudinal surface 360. The hooks 306a-306d have a thickness 362 that is defined between opposite parallel longitudinal surfaces of the hooks 306.

In some embodiments, the first hook 306a that is positioned at the corner between the first lateral surface 354 and the first longitudinal surface 356 extends in a direction from the first lateral surface 354 towards a center of the body 302 (e.g., in a lateral direction towards the longitudinal axis 304 or a centerline of the body 302). The first hook 306a extends outwards from the surface 320 and downwards from the first lateral surface 354 towards the center of the body 302. The third hook 306 similarly extends outwards from the surface 320 and downwards from the first lateral surface 354 towards the center of the body 302. The second hook 306b and the fourth hook 306d may extend in an opposite direction (e.g., mirrored about the longitudinal axis 304) from the surface 320 and the second lateral surface 358 towards the center of the body 302 (e.g., in the lateral direction or along the lateral axis 305). In this way, the cable holder 300 includes four hooks which alternate in their direction of extending from opposite lateral sides of the body 302 along the longitudinal length of the cable holder 300.

Referring still to FIGS. 2-3, each of the hooks 306 includes or defines a surface 318 that is configured to engage and at least partially surround the cable. In some embodiments, the surface 318 has a size and shape that is configured for the specific type or size of the cable. For example, if the cable is a 1 inch cable, the surfaces 318 may have a diameter that is substantially equal to an outer diameter of the cable (e.g., 1 inch, ¾ inches, etc.). In some embodiments, the surfaces 318 have a shape of a portion of an ellipse (e.g., when viewed along the longitudinal axis 304). The surfaces 318 can also have a circular shape, an arcuate shape, a sweep shape, a J-shape, etc. In some embodiments, the surfaces 318 begin at the surface 320 and extend to an end of the hook 306. In some embodiments, the surfaces 318 have a shape that is asymmetrical. For example, the surfaces 318 can have a J-shape, or can be a portion of an ellipse (e.g., beginning at a vertex or co-vertex of the ellipse and terminating at a point on the ellipse past the opposite vertex of co-vertex). In some embodiments, the surfaces 318 have the shape of an ellipse or circle (e.g., 180 degrees of an ellipse or a circle) with an additional curved or straight portion to facilitate further engagement of the cable). In some embodiments, the hooks 306 extend in the lateral direction to a lateral center or laterally central plane of the body 302, laterally beyond the lateral center or the laterally central plane of the body 302, etc. In some embodiments, the laterally central plane is normal to both the surface 320 and the lateral axis 305 and intersects the body 302 at a lateral midpoint of the body 302.

Referring still to FIGS. 2-3, the holes 310 may be positioned such that the fasteners 312 are accessible even when the cable is coupled with the cable holder 300 (e.g., positioned within the hooks 306). In particular, a first hole 310 may be positioned proximate the first hook 306a and the first lateral surface 354 (e.g., on an upper lateral half of the body 302) at a longitudinal position between the first hook 306a and the second hook 306b. A second hole 310 may be positioned proximate the second lateral surface 358 (e.g., on a bottom or second lateral half of the body 302 proximate the second lateral surface 358) at a longitudinal position between the longitudinal positions of the second hook 306b and the third hook 306c. In some embodiments, a third hole 310 is positioned proximate the first lateral surface 354 and the second longitudinal surface 360 (e.g., on the upper lateral half of the body 302) at a longitudinal position between the third hook 306c and the fourth hook 306d. In some embodiments, a fourth hole 310 is positioned proximate the corner defined by the first longitudinal surface 356 and the second lateral surface 358.

In some embodiments, the hooks 306 are manufactured from a material (e.g., a dense foam, a flexible plastic, etc.) that can flex and bend (e.g., plastically deform) so that if the cable is pulled in a direction away from the cable holder 300 (e.g., by a force at least partially in a direction away from the surface 320 and perpendicular to both the lateral axis 305 and the longitudinal axis 304), the hooks 306 may bend or deflect to allow the cable to be removed from the cable holder 300 without damaging the vehicle 10. Advantageously, the cable holder 300 includes four of the hooks 306 such that if one of the hooks 306 is damaged or broke, the cable holder 300 may still function to hold the cable. In some embodiments, the hooks 306 are uniformly spaced along the longitudinal axis 304.

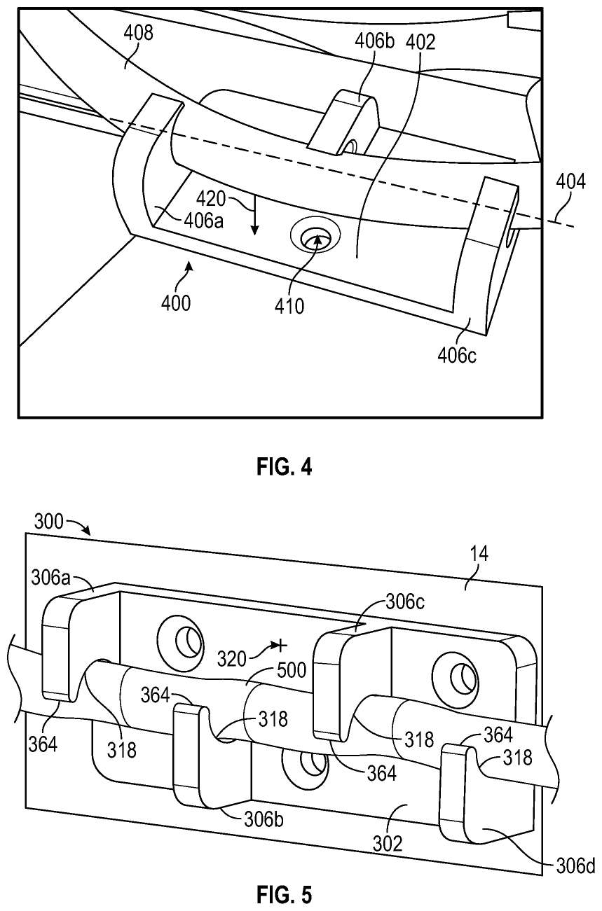

Referring particularly to FIG. 4, another cable holder 400 is shown. The cable holder 400 is similar to the cable holder 300 but includes only three of the hooks 406 (e.g., a first hook 406a, a second hook 406b, and a third hook 406c). The first hook 406a and the third hook 406c are positioned on a body 402 of the cable holder 400 on a surface 420, extending from the same lateral side towards a center of the body 402. The second hook 406b is positioned at a longitudinal midpoint (e.g., along a longitudinal axis 404) of the body 402, and extends from the lateral surface opposite the lateral surface that first hook 406a and the third hook 406c extend. In some embodiments, the cable holder 400 includes a single hole 410 that is configured to receive a fastener to couple the cable holder 400 to the vehicle 10.

Referring to FIG. 5, the cable holder 300 is shown with a cable 500 installed between the hooks 306. In some embodiments, the hooks 306 engage an exterior surface of the cable 500 such that the cable 500 is coupled with the hooks 306 in a frictional and interference fit. The cable 500 may also be engaged (e.g., contacted) by the surface 320 such that the cable 500 is engaged by the surfaces 318 and the surface 320 on multiple sides. In some embodiments, an end 364 of the hooks 306 extends at least partially around the cable 500 such that the cable 500 is engaged by the surfaces 318 of the hooks 306 and the surface 320 of the body 302 across 180 degrees of the cable 500. Advantageously, the cable 500 can be easily and quickly installed into the cable holder 300 and may be broken away from the cable holder 300 if pulled or tugged to thereby reduce a likelihood of damage to the body 14 (e.g., a fender) to which the cable holder 300 is coupled. In some embodiments, the cable holder 300 is configured to receive a cable of a tethered controller for a vehicle that does not include a steering wheel. Multiple cable holders 300 can be mounted on the vehicle 10 so that cables can be secured onto the cable holder 300 and reduce tripping hazards or reduce a likelihood of the cables hanging and becoming tangled in moving components. In some embodiments, the cable holder 300 is also suitable for use for a tubular member such as a fuel line, a removable gas line, a gas station hose, etc.

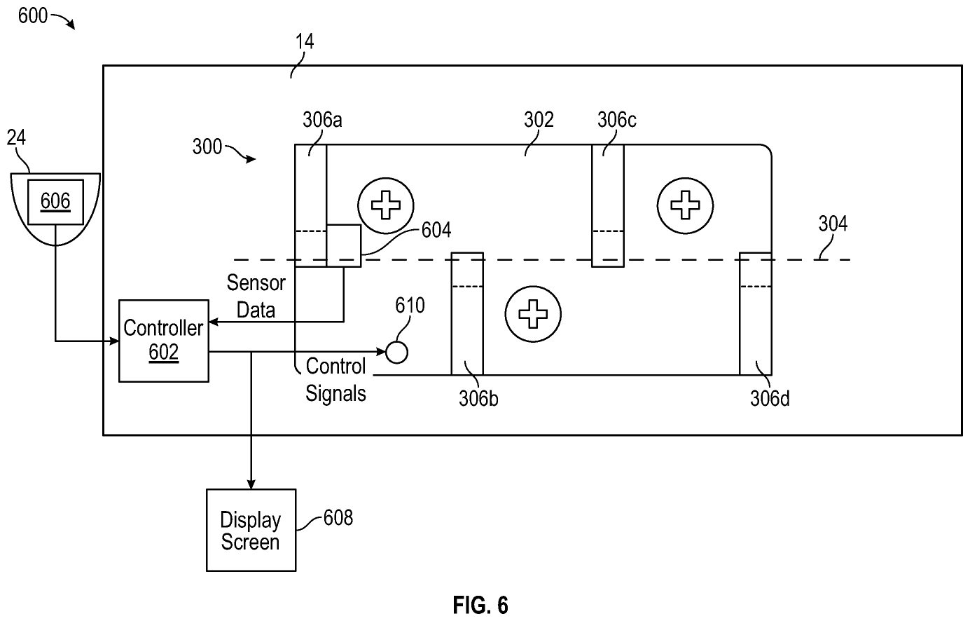

Referring to FIG. 6, the cable holder 300 (and/or the cable holder 400) can include a control system 600 for detecting if the cable 500 is installed on the cable holder 300. The control system 600 includes a controller 602 (e.g., a processing circuit, processing circuitry, a processor, etc.), a sensor 604, a connection sensor 606, a light emitting device 610 (e.g., a light emitting diode), and a display screen 608. In some embodiments, the sensor 604 is button or transducer that can be physically moved or pressed when the cable 500 is installed on the cable holder 300. In some embodiments, the sensor 604 is a current measurement device that is configured to generate a signal responsive to a current passing nearby (e.g., due to flow of electrical energy through the cable 500 when installed). In some embodiments, the sensor 604 is a distance sensor or a light sensor that can be positioned such that the sensor 604 is covered when the cable 500 is installed to thereby detect that the cable 500 is installed on the cable holder 300. The sensor 604 can provide sensor data to the controller 602 to notify the controller 602 if the cable 500 is installed on the cable holder 300 or not. The controller 602 can also receive data from the connection sensor 606 of the connector 24 (or any other connector) to determine if the cable 26 (e.g., the cable 500) has been connected with the charging station 200. If the cable 26 has been connected to the charging station 200, but the cable 26 is not installed on the cable holder 300, the controller 602 may generate control signals for the display screen 608 and/or the light emitting device 610 such that an operator or technician is notified that the cable 26 should be installed on or coupled on the cable holder 300 (e.g., operating the light emitting device 610 to emit red or orange light). Once the cable 26 is installed on or coupled with the cable holder 300, the controller 602 may detect the installation of the cable 26 on the cable holder 300 (e.g., based on the sensor data provided by the sensor 604), and adjust operation of the display screen 608 or the light emitting device 610 (e.g., by changing the light emitting device 610 to provide green or blue light).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A cable holder for a vehicle, the cable holder comprising:
a body portion defining an engagement surface and a plurality of holes;
a first hook, a second hook, and a third hook, wherein the first hook and the third hook extend from a first lateral side of the body portion and the second hook extends from a second lateral side of the body portion, wherein the first hook, the second hook, and the third hook each define a curved engagement surface;
wherein the first hook, the second hook, and the third hook are configured to receive a cable to removably couple the cable with the cable holder by engaging an exterior surface of the cable at the curved engagement surface;
wherein the body portion engages the exterior surface of the cable at the engagement surface; and
wherein the first hook, the second hook, and the third hook are manufactured from a flexible material such that the cable breaks away from the cable holder when a first force is exerted on the cable to pull the cable away from the cable holder without transferring a second force to a component of the vehicle that the cable holder is coupled to.

2. The cable holder of claim 1, wherein the plurality of holes are positioned on the body portion such that fasteners of the plurality of holes are accessible when the cable is engaged by the first hook, the second hook, the third hook, and the body portion.

3. The cable holder of claim 1, wherein the cable is a charging cable.

4. The cable holder of claim 1, wherein the first hook, the second hook, and the third hook, are evenly spaced along a longitudinal length of the body portion.

5. The cable holder of claim 1, wherein the first hook, the second hook, and the third hook are integrally formed with the body portion.

6. The cable holder of claim 1, wherein the first hook and the third hook extend from the first lateral side of the body portion towards a center of the cable holder, and the second hook extends from the second lateral side of the body portion toward the center of the cable holder.

7. The cable holder of claim 1, further comprising:
a fourth hook, wherein the fourth hook extends from the second lateral side of the body portion toward a center of the cable holder, and wherein the fourth hook defines a curved engagement surface.

8. The cable holder of claim 7, wherein the fourth hook is configured to receive the cable to removably couple the cable with the cable holder by engaging the exterior surface of the cable at the curved engagement surface.

9. The cable holder of claim 7, wherein the fourth hook is manufactured from the flexible material.

10. An electrical system for a vehicle, comprising:
a cable configured to transmit electrical energy; and
a cable holder comprising:
a body portion defining an engagement surface;
a first hook, a second hook, and a third hook, wherein the first hook and the third hook extend from a first lateral side of the body portion and the second hook extends from a second lateral side of the body portion, wherein the first hook, the second hook, and the third hook each define a curved engagement surface;
wherein the first hook, the second hook, and the third hook are configured to receive the cable to removably couple the cable with the cable holder by engaging an exterior surface of the cable at the curved engagement surface; and
wherein the first hook, the second hook, and the third hook are manufactured from a flexible material such that the cable breaks away from the cable holder when a first force is exerted on the cable to pull the cable away from the cable holder without transferring a second force to a component of the vehicle that the cable holder is coupled to.

11. The electrical system of claim 10, wherein the body portion includes a plurality of holes, and wherein the plurality of holes are positioned on the body portion such that fasteners of the plurality of holes are accessible when the cable is engaged by the first hook, the second hook, the third hook, and the body portion.

12. The electrical system of claim 10, wherein the body portion engages the exterior surface of the cable at the engagement surface.

13. The electrical system of claim 10, wherein the cable is a charging cable.

14. The electrical system of claim 10, wherein the first hook, the second hook, and the third hook are integrally formed with the body portion.

15. The electrical system of claim 10, wherein the cable holder further comprises a fourth hook, wherein the fourth hook extends from the second lateral side of the body portion toward a center of the cable holder, and wherein the fourth hook defines a curved engagement surface.

16. The electrical system of claim 15, wherein the fourth hook is configured to receive the cable to removably couple the cable with the cable holder by engaging the exterior surface of the cable at the curved engagement surface.

17. A vehicle, comprising:
a chassis coupled with a plurality of tractive elements;
a prime mover configured to drive the plurality of tractive elements to move the vehicle;
a body coupled with the chassis; and
a cable holder coupled with the body, wherein the cable holder comprises:
a body portion defining an engagement surface;
a first hook, a second hook, and a third hook, wherein the first hook and the third hook extend from a first lateral side of the body portion and the second hook extends from a second lateral side of the body portion, wherein the first hook, the second hook, and the third hook each define a curved engagement surface;
wherein the first hook, the second hook, and the third hook are configured to receive a cable to removably couple the cable with the cable holder by engaging an exterior surface of the cable at the curved engagement surface; and
wherein the first hook, the second hook, and the third hook are manufactured from a flexible material such that the cable breaks away from the cable holder when a first force is exerted on the cable to pull the cable away from the cable holder without transferring a second force to the body of the vehicle.

18. The vehicle of claim 17, wherein the body portion includes a plurality of holes, and wherein the plurality of holes are positioned on the body portion such that fasteners of the plurality of holes are accessible when the cable is engaged by the first hook, the second hook, the third hook, and the body portion.

19. The vehicle of claim 17, wherein the cable holder further comprises a fourth hook, wherein the fourth hook extends from the second lateral side of the body portion toward a center of the cable holder, and wherein the fourth hook defines a curved engagement surface.

20. The vehicle of claim 19, wherein the fourth hook is configured to receive the cable to removably couple the cable with the cable holder by engaging the exterior surface of the cable at the curved engagement surface.
